(19) United States
(12) Patent Application Publication
(10) Pub. No.: US 2007/0133928 A1
(43) Pub. Date: Jun. 14, 2007

(54) Canted-fiber duplex optical assembly

(75) Inventors: Chih-Hsiang Ko, Tainan City (TW); Ming-Lang Tsai, Ping-Tung (TW); Hui-Chuan Lu, Hsin-Chu (TW); Jin-Sheng Chang, Kaohsiung City (TW)

Correspondence Address: Venable LLP;Raymond J. Ho, 575 7th Street NW, Washington, DC, 20004-1601, US

(73) Assignee: Industrial Technology Research Institute, Hsin-Chu (TW)

(21) Appl. No.: 11/373,186

(22) Filed: Mar. 13, 2006

(30) Foreign Application Priority Data
Dec. 9, 2005 (TW) 94143602

(51) Int. Cl. G02B 6/36

(52) U.S. Cl. 385/88; 385/92; 385/93

(57) ABSTRACT

A canted-fiber duplex optical subassembly is disclosed herein. The optical subassembly transmits and receives optical signals by way of a single optical fiber, which has a canted surface on one end. A light source sends transmission optical signals, which are refracted through the canted surface and then enter the optical fiber. Reception optical signals in the optical fiber are reflected by the canted surface and are then received by an optical detector.

### BACKGROUND OF THE INVENTION

1. Field of the Invention

The present invention generally relates to an optical subassembly, and more particularly to a canted-fiber duplex optical subassembly and its package.

2. Description of the Prior Art

In traditional optical communication systems, in order to attain bi-directional communication purpose, two optical fibers, i.e., one for input and the other for output, are used to transfer optical signals of the same (or different) wavelengths. As transfer distance increases, the quantity and demand of users rise rapidly, and the deployment cost of optical fiber network is taken into consideration, somebody proposes a wave-division-multiplex communication technology to attain full-duplex purpose, wherein only a single optical fiber is used to transmit and receive two optical signals of different wavelengths. For example, transmitting optical signals with the wavelength 1310 nm and receiving optical signals with the other wavelength 1550 nm are transferred within the same single optical fiber. Furthermore, two Wavelength Division Multiplex (WDM) filters are respectively added on the transmission side and the reception side to separate optical signals of different wavelengths to achieve the bi-directional communication purpose.

Although the above-mentioned optical communication framework can be deployed at lower cost, an additional pair of WDM filters makes processes and assembly more difficult, and is still costly. In the fabricating processes of the WDM filter, several tens of optical films are repeatedly deposited, and each film should be controlled within several microns. In assembly, the thickness of the WDM filter will significantly affect the optical coupling efficiency between optical path and optical fiber. In general, it is necessary to take time-consuming active alignment to complete the assembly.

FIG. 1 shows a cross-sectional diagram of a traditional wave-division-multiplex optical transceiver module. The details are disclosed in World Patent No WO03104850 entitled ‘System, Methods and Apparatus for Bi-directional Optical Transceivers.’ The optical subassembly uses TO-Can method to assemble light source subassembly 17 and optical detector subassembly 18. A laser light source and a single-mode optical fiber 16 are assembled by active alignment. That is, during the optical coupling process, it is necessary to drive active components (such as Laser Diode, LD) and photodiode (PD), and then joint and fix the active components after active alignment of optical coupling machine. More importantly, the optical subassembly needs a WDM filter to separate the optical signals of different wavelengths. This type of optical subassembly not only induces a bigger volume but also a higher cost in active alignment and TO-Can assembly.

FIG. 2 shows a cross-sectional diagram of another traditional division-wavelength-multiplex optical subassembly. The details are disclosed in US Patent Application No 20010033716 entitled ‘Structure for Shielding Stray Light in Optical Waveguide Module’ or IEEE Electronics Components and Technology Conference 2003 paper entitled ‘A Bidirectional Single Fiber 1.25 Gb/s Optical transceiver Module with SFP Package using PLC.’ The optical subassembly is fabricated by Planar Light-wave Circuit (PLC) process. The planar waveguide 22 is a medium of optical communication. The optical signal is emitted by laser diode 23, and then enters the planar waveguide 22, and is then reflected into single-mode optical fiber 25 by WDM filter 26. Another optical signal is input from the single-mode optical fiber 25, and enters planar waveguide 22, and is finally received by photodiode 28 through WDM filter 26. Accordingly, the bi-directional communication is completed. However, to fabricate the planar waveguide 22 and V-groove 24 on planar waveguide substrate 21 at the same time is rather complicated. As a result, it is difficult to reduce its manufacturing cost by using this type of optical subassembly.

No matter for TO-Can optical subassembly (FIG. 1) or planar waveguide optical subassembly (FIG. 2), it is necessary for them to use WDM filters to perform bidirectional communication, and it causes several drawbacks such as bigger volume, complex alignment assembly, low coupling efficiency, more components and high manufacturing cost. Therefore, there is a need for a new optical subassembly, which can omit WDM filter, shrink its volume, reduce manufacturing cost, simplify assembly processes and increase coupling efficiency.

### SUMMARY OF THE INVENTION

One object of the present invention is to provide a canted-fiber duplex optical subassembly to simultaneously transmit and receive optical signals.

Another object of the present invention is to provide a canted-fiber duplex optical subassembly, which is fabricated by MEMS technology or OEIP technology to simplify the assembly and reduce manufacturing cost.

According to the above-mentioned objects, the present invention provides a canted-fiber duplex optical subassembly, which simultaneously transmits and receives optical signals over a single optical fiber with a canted surface on one end. A light source sends transmission optical signals, which are refracted through the canted surface and then enter the optical fiber. Reception optical signals in the optical fiber are reflected by the canted surface and then are received by an optical detector.

According to one embodiment, the present invention provides an OptoElectronics Integrated Package (OEIP) structure and a fabricating method of a canted-fiber duplex optical subassembly. First, a canted surface is formed on one end of an optical fiber. Then, the optical fiber, a light source and an optical detector are fixed on a substrate. The light source sends transmission optical signals, which are refracted through the canted surface and then enter the optical fiber. Reception optical signals in the optical fiber are reflected by the canted surface and then are received by the optical detector. Finally, a package is covered to protect the optical fiber, the light source, the optical detector and the substrate.

### BRIEF DESCRIPTION OF THE DRAWINGS

FIG. 1 shows a cross-sectional diagram of a traditional wave-division-multiplex optical transceiver module.

FIG. 2 shows a cross-sectional diagram of another traditional wave-division-multiplex optical transceiver module.

FIG. 3A shows a side view of a canted-fiber duplex optical subassembly according to one embodiment of the present invention.

FIG. 3B shows a top view of a canted-fiber duplex optical subassembly according to one embodiment of the present invention.

FIG. 4A shows a diagram of operation mechanism on optical transmission side according to the present invention.

FIG. 4B shows a diagram of operation mechanism on optical reception side according to the present invention.

FIG. 5A shows a diagram of operation theory of a canted-fiber duplex optical subassembly on optical transmission side according to the present invention.

FIG. 5B shows a diagram of operation theory of a canted-fiber duplex optical subassembly on optical reception side according to the present invention.

FIG. 6 shows an optical-path example of applied framework of the present invention.

FIGS. 7A, FIG. 7B and FIG. 7C show the perspective views of a structure and a fabricating method of an OEIP of a canted-fiber duplex optical subassembly according to one embodiment of the present invention.

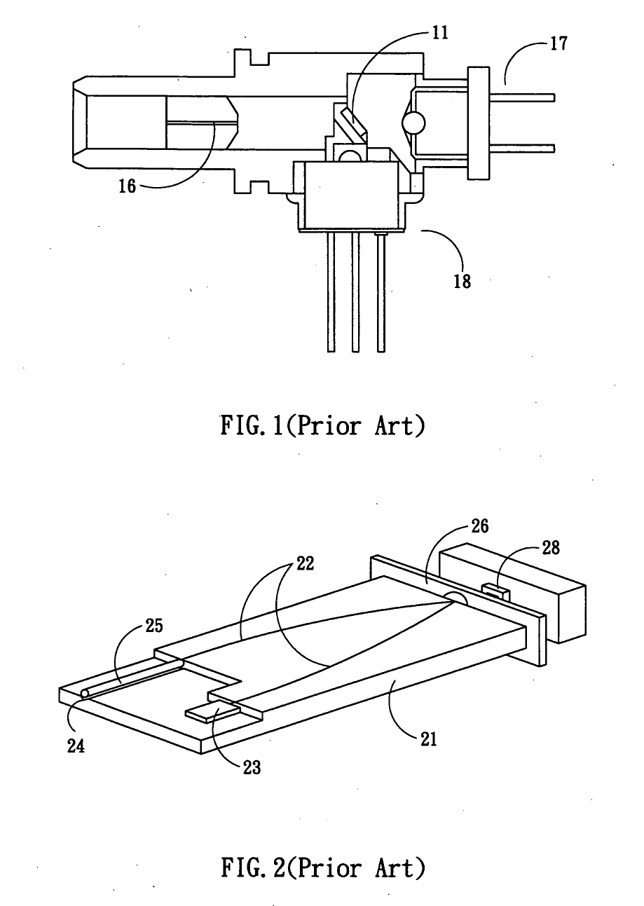

### DETAILED DESCRIPTION OF THE INVENTION

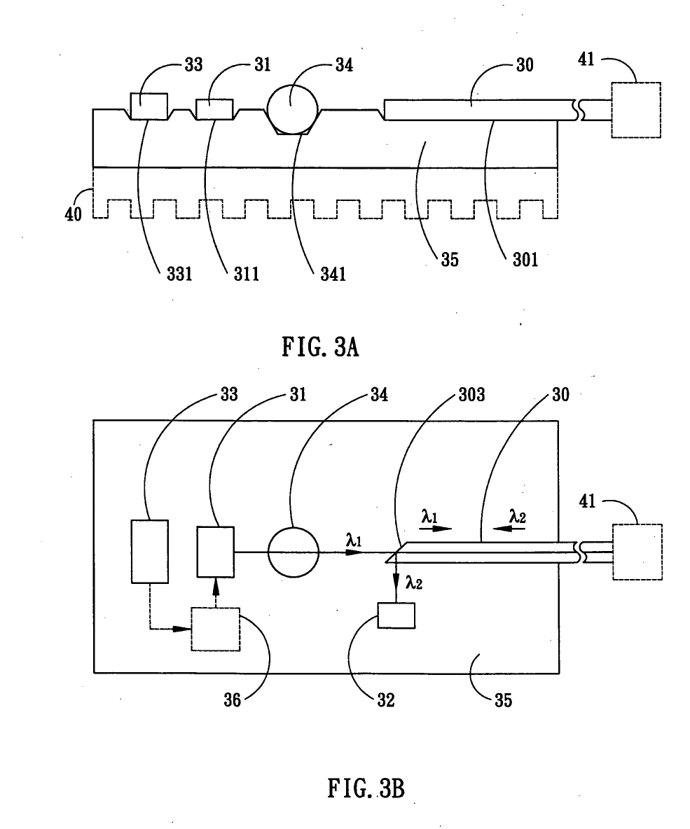

FIG. 3A is a diagram illustrating side view of canted-fiber duplex optical subassembly according to an embodiment of the present invention. FIG. 3B is a top view of FIG. 3A. According to the embodiment of the present invention, a single optical fiber 30 is used to transmit and receive optical signals to achieve full duplex communication. As shown in the figure, the wavelength of the transmission optical signal is λ₁ such as 1310 nanometers, and that of the reception optical signal is λ₂ such as 1550 nanometers. The wavelengths of the two optical signals can be different, or the same. The optical fiber 30 of the present invention can be of any kinds of optical fibers, such as single-mode optical fiber, multi-mode fiber or plastic optical fiber. One characteristic of the present invention is that the optical fiber 30 has a canted surface 303 on one end. The canted surface 303 of the optical fiber 30 is used to refract the transmission optical signals and reflect the reception optical signals. The operation mechanism and operation theory will be described in the following paragraphs and figures. In the present invention, for illustration purpose the specified angle of the canted surface of the optical fiber 30 is 45 degrees, but is not limited to this angle. The angle can be adjusted depending on conditions. For example, it can be adjusted according to the refractive index of the utilized optical fiber.

The above-mentioned transmission optical signals λ₁ is emitted by a light source 31. In the present embodiment, the light source 31, which is a bare chip diode such as edge emitting laser diode or surface emitting laser diode, emits the transmission optical signals of a specified wavelength λ₁ through the canted surface 303 with a specified angle, and then into the core of the optical fiber 30. The above-mentioned reception optical signals λ₂ are reflected by the canted surface 303 of the optical fiber 30 with a specified angle, and then are received by an optical detector 32. In this embodiment, the optical detector 32 is a bare chip photodiode, such as edge illuminated photodiode, or surface illuminated photodiode. The optical detector 32 usually has an optical detecting area of several tens of square microns, but it is not limited to this scope.

In addition to the main components such as the above-mentioned optical fiber 30, the light source 31, and the optical detector 32, the embodiment of the present invention further includes a monitor component 33 placed next to the light source 31 (the rear area) to monitor the variation of the output optical power from the light source 31. The output power or output wavelength emitted by the light source 31 could be affected by aging, temperature or humidity so that it is necessary to have a monitor component 33 to monitor its output conditions. Once the output signal over the preset value is found, the bias circuit 36 will feedback to the light source 31 to control the bias-voltage level of the light source 31, and to maintain the output power or output wavelength within preset range. The embodiment of the present invention further includes an optical component 34 placed between the light source 31 and the optical fiber 30. The optical signals λ₁ emitted by the light source 31 is focused to provide a wider coupling alignment tolerance accordingly. In the present embodiment, the optical component 34 is ball lens. However, other optical components, such as micro-lens or Graded-Index lens (GRIN lens), are also suitable for the use. In the present embodiment, the afore-mentioned optical fiber 30, light source 31, optical detector 32, monitor component 33, and optical component 34 are carried by a substrate 35, and respectively fixed on optical fiber groove 301, light source groove 311, optical detector groove, monitor component groove 331, and optical component groove 341. The substrate 35 not only serves as a carrier but also provides the structure design for assembly alignment. Furthermore, a heat sink 40 can be placed at the backside of the substrate 35 to enhance the radiation efficiency of the light source 31. Besides, there is a connector 41, such as conventional Fiber Connector (FC), Subscriber Connector (SC), Straight Tip (ST) connector or Lucent Connector (LC), at the other end of the optical fiber 30, which is used to connect other optical fibers or other optical assemblies.

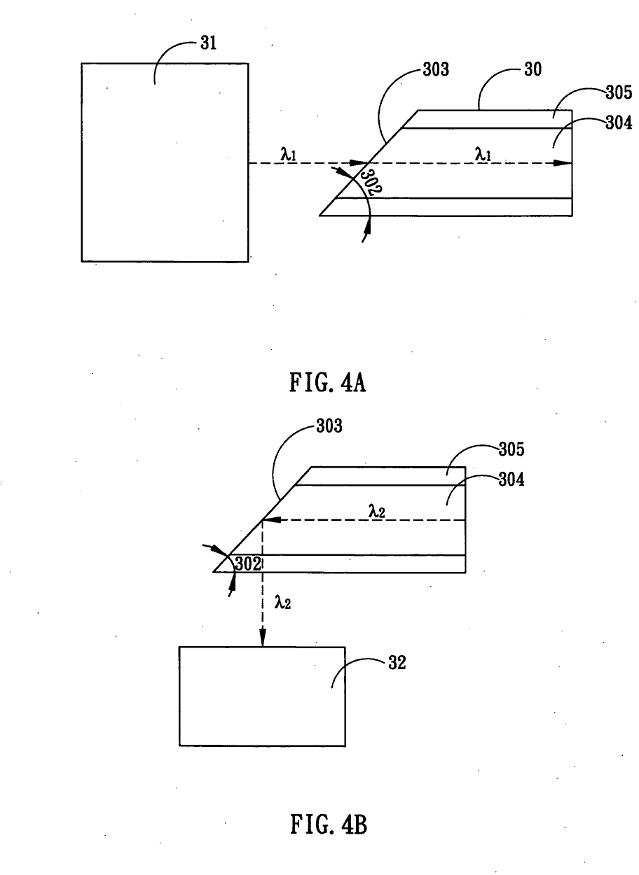

FIG. 4A and FIG. 4B respectively shows the operation mechanisms of a canted-fiber duplex optical subassembly on optical transmission side and optical reception side according to the present invention. As shown in FIG. 4A, on the operation mechanism of the optical transmission side, the optical signals λ₁ of a specified wavelength are emitted by the light source 31, and are refracted into the core 304 of the optical fiber 30 through canted surface 303 with a specified angle 302. The refractive index of the core 304 is greater than that of the cladding 305, so that the optical signals can travel out by total reflection method. As shown in FIG. 4B, on the operation mechanism of the optical reception side, from the core 304 of the optical fiber 30 the reception optical signals λ₂ are reflected into the detecting area of the optical detector 32 by the canted surface 303 with the specified angle 302.

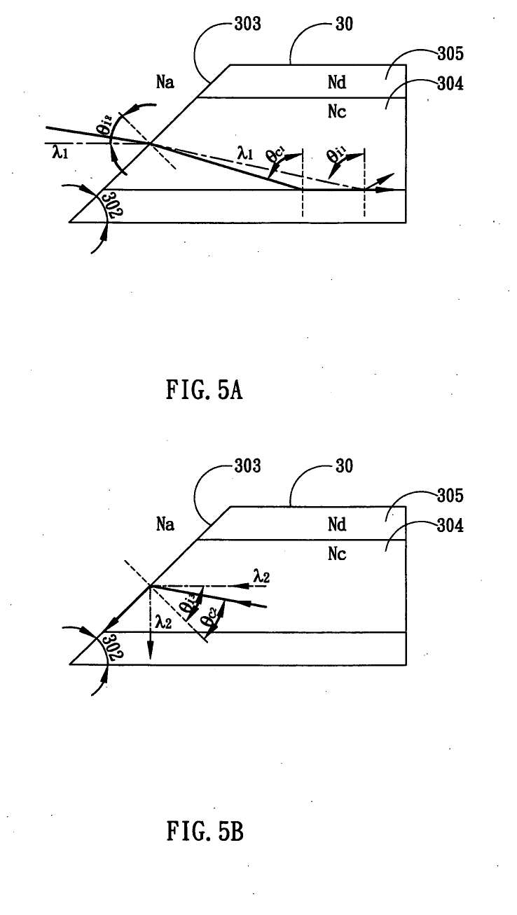

FIG. 5A and FIG. 5B respectively show the operation theories of a canted-fiber duplex optical subassembly on optical transmission side and optical reception side according to the present invention. On the optical transmission side, as shown in FIG. 5A, in order to travel inside the optical fiber, the optical signals λ₁ have to satisfy the total reflection condition, that is, the first incident angle θᵢ₁ has to be greater than the first critical angle θ_{c1}. Furthermore, when the optical signals λ₁ enter the core 304 of the optical fiber from the air (its refractive index is about Nₐ) through the canted surface 303 with a specified angle 302, the optical signals λ₁ partially are reflected and partially refracted. The bigger the second incident angle θᵢ₂ is, the higher the reflective percentage is, and the lower the refractive percentage is. On the reception side, as shown in FIG. 5B, when the optical signals λ₂ are reflected into the optical detector from the core 304 of the optical fiber by the canted surface 303 with a specified angle 302, and the third incident angle θᵢ₃ is greater than the second critical angle θ_{c2}, total reflection happens and the optical signals λ₂ are completely reflected into optical detector. Therefore, once the optical fiber is chosen, that is, the refractive index N_{c} of the core and the refractive index N_{d} of the cladding are chosen, then by adjusting the specified angle 302 of the canted-fiber and cooperatively adjusting the incident angle θᵢ₂ of the light source and receive angle of the optical detector, the optical subassembly can get a better performance.

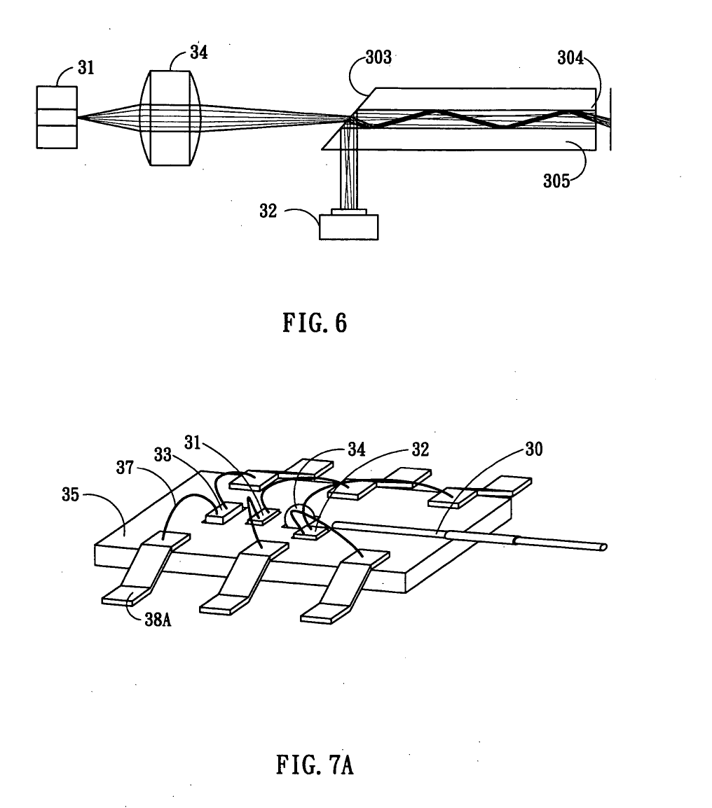

According to the framework and operation theory of the above-mentioned embodiment, the following provides an exemplary application illustrating optical paths of the present invention, as shown in FIG. 6. When the refractive index N_{d} of the cladding 305 is about 1.47, the specified angle of the optical fiber is about 45 degrees, and the refractive index N_{c} of the core 304 is greater than 1.65, that is, greater than that of the core of general optical fiber, whose N_{c} is about 1.5, we can get smaller second incident angle θᵢ₂, and then the transmission optical signal λ₁ can be mostly refracted into the core 304 and travel by total reflection method inside the core 304. Furthermore, the reception optical signal λ₂ can also mostly enter the optical detector 32. Therefore, by using the higher refractive index N_{c} of the optical fiber and cooperatively adjusting the specified angle 302 of the canted-fiber, incident angle θᵢ₂ of transmission optical signal, and the detecting angle of optical detector for receiving optical signals, the optical subassembly can get a better performance according to the present invention.

With regard to the fabrication of the canted surface with the specified angle at one end of the optical fiber, it can be fabricated by using the optical fiber polishing machine. First, a termination of a bare optical fiber is fixed on optical fiber clamping apparatus to control the specified polishing angle, and then polished one by one from coarse polishing pads to fine polishing pads to avoid the roughness on the canted surface, and finally make the surface free from affecting the input and output of the optical signals. Besides polishing technology, other technologies such as etching or cutting can adopted for fabricating the canted surface of the optical fiber.

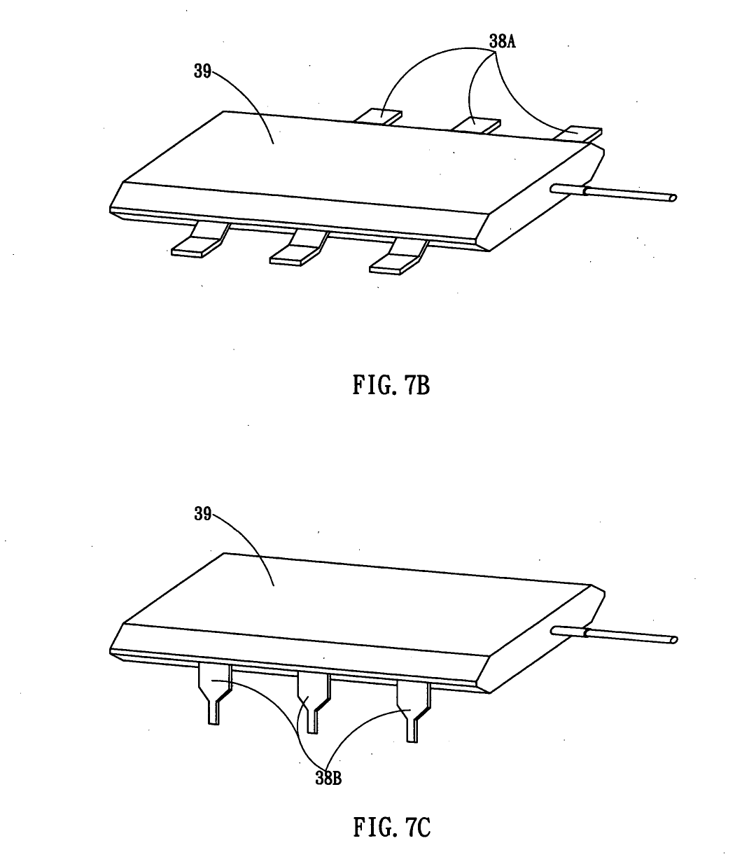

FIG. 7A, FIG. 7B and FIG. 7C show the perspective views of a structure and a fabricating method of an OptoElectronics Integrated Package (OEIP) of a canted-fiber duplex optical subassembly according to the embodiment of the present invention. First, a substrate 35 is fabricated by Micro-Electro-Mechanical Systems (MEMS) method. An optical fiber groove 301, a light source groove 311, an optical detector groove, a monitor component groove 331, and optical component groove 341, etc., which are U-groove or V-groove with predetermined patterns, depths and profiles, are formed on the surface of the substrate 35. Besides, there is a canted surface with the same specified angle on one end of the optical fiber groove 301 as the optical fiber. Alternatively, the substrate 35 can be fabricated by Micro-Injection Molding (MIM) technology. That is, the substrate 35 is fabricated by MEMS method, and then a mold is fabricated by mold forming technology. Next, the substrate 35 is fabricated by MIM technology. The material of the substrate 35 can be general semiconductor material, polymer material, metal material or combination of them. Then, the optical fiber 30, the light source 31, the optical detector 32, the monitor component 33 and the optical component 34 are respectively and placed in the corresponding grooves, as shown in FIG. 7A. The packaging structure and method provide a structure design of easy alignment and easy assembly to simplify the assembly and reduce manufacturing cost. Next, a lead frame 38A is jointed to the surface of the substrate 35. The lead frame 38A having two rows of isolated metal leads is a medium of transferring electrical signals with outside world. The lead frame 38A connected to the outside is by Surface Mount Technology (SMT), as shown in FIG. 7A and FIG. 7B, or by Pin-Through-Hole (PTH) method, as shown in the lead frame 38B of FIG. 7C. Then, by wire bonding method the bonding wires 37 such as gold wires are bonded between the bonding pads of the bare chips and lead frame (38A or 38B). Finally, by molding process the package 39 encapsulates the whole substrate 35 to protect the components inside, that is, the optical fiber 30, the light source 31, the optical detector 32, the monitor component 32, the optical component 34, the substrate 35 and part of the lead frame (38A or 38B), as shown in FIG. 7B. The material of package 39 is molding compound such as ceramic material or plastic material. Before the molding process, index matching paste (not shown in the figure) can be filled between the light source 31 and the optical fiber 30 to enhance the coupling efficiency of the optical fiber 30. The method for easily assembling the optical subassembly by the package processes of the present invention can be applied to Electronic-Optical Circuit Board (EOCB) to assemble any kinds of optoelectronic integrated systems.

The canted-fiber duplex optical subassembly disclosed by the present invention can simultaneously transmit and receive optical signals without interference, even though the wavelengths of the optical signals are the same. By using a single optical fiber and a single wavelength, the present invention can achieve full duplex communication purpose to transmit and receive different signals. According to the embodiment of the present invention, the optical subassembly without using WDM filter can not only shrink the size of the optical subassembly, but also reduce the manufacturing cost. Besides, the optical fiber can be directly aligned to other active components by grooves in the substrate. That is, the passive alignment assembly technology can be adapted. Furthermore, the optical component is used to enhance the coupling efficiency and greatly improve the optical output efficiency of the assembly. Besides, MEMS or OEIP technology is used to simplify the assembly and reduce the manufacturing cost.

Although specific embodiments have been illustrated and described, it will be appreciated by those skilled in the art that various modifications may be made without departing from the scope of the present invention, which is intended to be limited solely by the appended claims.

What is claimed is:

1. A canted-fiber duplex optical subassembly, comprising:
an optical fiber with a canted surface on one end;
a light source emitting transmission optical signals into said optical fiber through said canted surface; and
an optical detector receiving and detecting reception optical signals, which are reflected by said canted surface from inside of said optical fiber.

2. The canted-fiber duplex optical subassembly according to claim 1, wherein said optical fiber is single-mode optical fiber, multi-mode optical fiber, or plastic optical fiber.

3. The canted-fiber duplex optical subassembly according to claim 1, further comprising a connector connected to the other end of said optical fiber, wherein type of said connector is FC, SC, ST, or LC connector.

4. The canted-fiber duplex optical subassembly according to claim 1, further comprising a substrate to carry said optical fiber, said light source, and said optical detector.

5. The canted-fiber duplex optical subassembly according to claim 4, wherein surface of said substrate has a plurality of grooves to respectively fix said optical fiber, said light source and said optical detector.

6. The canted-fiber duplex optical subassembly according to claim 1, wherein said light source is edge emitting laser diode, surface emitting laser diode or light emitting diode.

7. The canted-fiber duplex optical subassembly according to claim 1, further comprising an optical component placed between said light source and said optical fiber to increase coupling efficiency of said optical fiber.

8. The canted-fiber duplex optical subassembly according to claim 7, wherein said optical component is ball lens, micro-lens, or GRIN lens.

9. The canted-fiber duplex optical subassembly according to claim 1, further comprising a monitor component placed next to said light source to monitor output optical power of said light source.

10. The canted-fiber duplex optical subassembly according to claim 9, further comprising a bias circuit controlled by said monitor component to control bias-voltage level of said light source.

11. The canted-fiber duplex optical subassembly according to claim 1, wherein said optical detector is edge illuminated photodiode or surface illuminated photodiode.

12. The canted-fiber duplex optical subassembly according to claim 1, wherein said canted surface of said optical fiber and perimeter of said optical fiber construct an angle of about 45 degrees.

13. The canted-fiber duplex optical subassembly according to claim 4, further comprising a package covering and protecting said optical fiber, said light source, said optical detector and said substrate.

14. The canted-fiber duplex optical subassembly according to claim 1, further comprising index matching paste filled between said light source and said optical fiber to enhance coupling efficiency of said optical fiber.

15. The canted-fiber duplex optical subassembly according to claim 1, further comprising a lead frame as a medium for transferring electrical signals with outside of the subassembly.

16. The canted-fiber duplex optical subassembly according to claim 15, further comprising bonding wires bonded among said light source, said optical detector and said lead frame.

17. A method for packaging a canted-fiber duplex optical subassembly, comprising:
providing a substrate;
forming a canted surface on one end of an optical fiber and placing said optical fiber on said substrate;
placing a light source on said substrate to emit transmission optical signals into said optical fiber through said canted surface;
placing an optical detector on said substrate to receive and detect reception optical signals, which are reflected by said canted surface from inside of said optical fiber; and
covering a package to protect said optical fiber, said light source, said optical detector and said substrate.

18. The method for packaging the canted-fiber duplex optical subassembly according to claim 17, further comprising forming a plurality of grooves on surface of said substrate to respectively fix said optical fiber, said light source and said optical detector.

19. The method for packaging the canted-fiber duplex optical subassembly according to claim 17, further comprising placing an optical component between said light source and said optical fiber to enhance the coupling efficiency of said optical fiber.

20. The method for packaging the canted-fiber duplex optical subassembly according to claim 17, further comprising placing a monitor component next to said light source to monitor output optical power of said light source.

21. The method for packaging the canted-fiber duplex optical subassembly according to claim 20, further comprising placing a bias circuit controlled by said monitor component to control bias-voltage level of said light source.

22. The method for packaging the canted-fiber duplex optical subassembly according to claim 17, wherein said canted surface of said optical fiber is polished, etched or cut to an angle about 45 degrees relative to perimeter of said optical fiber.

23. The method for packaging the canted-fiber duplex optical subassembly according to claim 17, further comprising filling index matching paste between said light source and said optical fiber to enhance the coupling efficiency of said optical fiber.

24. The method for packaging the canted-fiber duplex optical subassembly according to claim 17, further comprising placing a lead frame as a medium for transferring electrical signals with outside of the subassembly.

25. The method for packaging the canted-fiber duplex optical subassembly according to claim 24, further comprising bonding wires among said light source, said optical detector and said lead frame.
